(19) United States
(12) Patent Application Publication
(10) Pub. No.: US 2004/0122968 A1
(43) Pub. Date: Jun. 24, 2004

(54) Device for transmitting digital signals among mobile units at a variable transmission rate

(76) Inventors: Harry Schilling, Eichstatt (DE); Nils Krumme, Feldafing (DE); Georg Lohr, Eichenau (DE)

Correspondence Address: CONLEY ROSE, P.C., P.O. BOX 684908, AUSTIN, TX, 78768, US

(21) Appl. No.: 10/674,877

(22) Filed: Sep. 29, 2003

(30) Foreign Application Priority Data
Sep. 27, 2002 (DE) 10245450.7

(51) Int. Cl. G06F 15/16

(52) U.S. Cl. 709/232; 709/233

(57) ABSTRACT

A device for transmitting digital signals between two units mobile relative to each other, in particular via non-contacting rotary joints, comprises a controller on a transmitter side for controlling an issued data rate or data package size of digital signals according to transmission characteristics of a data transmission path so as to achieve an optimum transmission. An optional analyzer means on a receiver side regenerates original signals so that a conversion remains hidden, but a substantially more reliable transmission is achieved.

### FIELD OF THE INVENTION

The present invention relates to a device for transmitting digital signals among a plurality of units mobile relative to each other.

For the sake of clarity, in the present document, the transmission between units mobile relative to each other, on the one hand, is not distinguished from the transmission between a stationary unit and units mobile relative to the first unit, on the other hand, because this is only a question of local relationship and does not take any influence on the mode of operation of the invention. Equally, a distinction is not made between the transmission of signals and energy because the mechanisms of operation are the same in this respect.

### PRIOR ART

In units mobile along a linear path, such as crane and conveyor installations, as well as in rotary units such as radar systems and also computer tomographs, it is necessary to transmit electrical signals or energy, respectively, between units mobile relative to each other. To this end, mostly a conductor array is provided in the first unit and corresponding tapping means are provided in the second unit. The term “conductor arrays” as used in the description given below refers to any forms whatsoever of conductor arrays conceivable, which are suitable for conducting electrical signals. This refers also to the known contacting sliding paths or sliding rings, respectively.

A suitable device is described in the laid-open German Patent Application DE 44 12 958 A1. There, the signal to be transmitted is supplied into a strip conductor of the first unit that is arranged along the path of the movement of the units mobile relative to each other. The signal is tapped by the second unit by means of capacitive or inductive coupling.

The coupling factor of the signal between the two units is substantially a function of the distance of the two units from each other. Particularly in transmission systems with three-dimensional extension and especially in the event of high speeds of movement, the distances between the mobile units cannot be determined with an optional precision, which is due to the mechanical tolerances. As the position of the two units relative to each other and the speed (e.g. caused by vibrations) and other influential parameters vary, the coupling factor frequently varies therefore, too. At the same time, the signal amplitude at the receiver input varies as well. This results in variations in the signal in receivers presenting the conventional design, which are noticeable, for instance, in the form of an increased jittering or even bit errors. Moreover, variations of the noise immunity occur likewise as a result.

The device disclosed in DE 197 00 110 A1 leads to an improvement of the transmission characteristics, which device presents a conductor array with filter features instead of a strip line. On principle, however, the problems remain as they are.

The U.S. Pat. No. 6,433,631 B2 discloses a device for feedback control of the input level at the receiver. To this end, the signal amplitude is measured downstream of a pre-amplifier whilst an attenuator element is controlled in correspondence with this signal amplitude, which is provided ahead of the pre-amplifier. The disadvantage of this system resides in the aspect that it can exclusively make a signal available to the receiver, which presents a constant amplitude.

The disadvantage of the devices according to prior art resides in a still insufficient noise immunity. Even though the levels of the transmitted signal can be increased on the line in order to improve the noise immunity the undesirable radiation of high-frequency signals increases as well. As a matter of fact, a reduction of the level of the transmitted signal reduces the radiation but the immunity to stray-in interference from the outside is reduced as well.

### BRIEF DESCRIPTION OF THE INVENTION

The present invention is based on the problem of designing a device for the transmission of electrical signals, which avoids the aforementioned disadvantages and presents in particular a high noise immunity and hence a high quality of signal transmission.

In accordance with the present invention, this problem is solved with the means defined in the independent Claims. Expedient improvements of the invention are the subject matters of the dependent further claims.

An inventive device serves to transmit digital signals between at least two units mobile relative to each other. It is, of course, possible to arrange one or more units on each side of the movement. For a simplified representation, here reference is made exclusively to a second unit that is mobile relative to a first unit.

A data source (1) for generating a serial data stream such as a parallel-to-serial converter according to prior art is associated with the first unit. Moreover, a transmitter (2) is provided that generates electrical signals from the serial data stream of the data source for the transmission via a transmitter conductor array (3). A receiving antenna (4) for tapping electrical signals in the near field of the transmitter conductor array is associated with the second unit. The electrical signals of the receiving antenna are supplied via a receiver (5) to a data sink (6) for subsequent processing of the signals.

In accordance with the invention, a controller (7) is provided that controls optionally the data source (1) or the transmitter (2) in correspondence with a desired value for the emission of a certain data rate or package size, respectively. Optionally, the controller may also be disposed between a data source (1) and the transmitter (2) and designed in such a way that it formats directly the data rate or package size emitted by the data source (1) in correspondence with a desired value. Hence, the emission of the data can be adapted to the respective characteristics of the data transmission path.

The essential feature of the controller is its adaptation of the coding of an optional digital signal to the transmission characteristics of its path of electrical data transmission between the transmitter and the receiver.

With an inventive device, a quality of signal transmission can be achieved which is substantially better than the quality of prior art.

It is optionally also possible to provide a decoder means in the second unit, between the receiver (5) and the data sink (6), for the conversion of the data rate or the package size, respectively, into the data rate or package size issued by the data source (1).

With this decoder means, the coding of the data from the first unit is cancelled so that the signals supplied to the data sink correspond to the data stream from the data source (1). It is, of course, possible to dispose the decoder means also in the receiver (5). In this manner, the coding is completely transparent to the data source or the data sink, respectively, for the optimum transmission of the data along the data transmission path.

Particularly in the case of units mobile relative to each other, the actual data rate to be transmitted varies frequently in the course of time or along with a variation of the position. Influential parameters are, for example, the distance between the two units mobile relative to each other, the coupling among the units or even external interfering influences. The coding means serves to adapt the data rate continuously. When, for example, at a certain point of time or at a predetermined position, the transmission is possible only at a comparatively low data rate the data from the data sources is buffered in the storage means. When with the lapse of time or with a change of the position the possible data rate along the data transmission path is increased again the buffered information may be transmitted. The decoder means is designed in correspondence therewith, which equally comprises means for storing data in the case of a high data rate from the coding means and is hence able to ensure a continuous data stream towards the data sink. Optional means are provided for optimum control in order to measure the transmission characteristics.

In transmission systems of the claimed general type, mostly a closed transmission path is provided along the track of the movement of the two units. A closed transmission path is involved when the transmitter conductor array (3) is linked up with the receiving antenna (4) so that data can be transmitted. As an alternative, the transmission path may also be subdivided into segments, which means that it may be composed of several parts. In an extreme case, the transmission path could consist of a single segment that is provided at a defined position. In such a case, control is carried out by the controller in such a way that transmission takes place exclusively at those positions where segments of the transmission path are present.

In another embodiment of the invention, the controller is so designed that it comprises means for storing data. With this provision, it becomes possible to adapt the data rate or segmentation into different package sizes without loss of data.

According to a further expedient embodiment of the invention, a rated-value generator is provided that sets the desired value and adapts optionally the setting of the desired value in a dynamic manner in correspondence with the characteristics of the transmission path such as the transmission quality, the bit error ratio, the signal-to-noise ratio or simply on the basis of the position of the two mobile units relative to each other or of a point of time.

In another expedient embodiment of the invention, the coding means comprises additional storing means as well as means for adapting the data rate of the serial data stream to be transmitted. It is hence possible to adapt the data rate in correspondence with the actual transmission characteristics of the transmission path between the transmitter and the receiver.

According to a further expedient embodiment of the invention, the controller comprises additional means for storing the data. Apart therefrom, an additional communication channel is provided between an additionally provided analyzer means between the receiver (5) and the data sink (6) as well as the controller for having faulty data signaled by the analyzer means to the controller. When the analyzer means establishes that data has been incorrectly transmitted this fact is signaled to the controller that responds with a repetition of the transmission of the data. Such mechanisms are fundamentally known at higher levels in signal transmission. In these case, there is hence a communication between a first computer, which is connected to the data sources, and a second computer, which is connected to the data sink. In such an array, the communication and the repetition of the data transmission requires additional computing power. With incorporation into a lower level of data transmission, the transmission is repeated independently of the transmission log and independently of additional expenditure for the communicating computers. The inventive device can hence be operated independently of the computer systems connected to it. At the same time, it ensures a maximum of flexibility and reliability in transmission at a minimum additional load on the connected computers.

According to another expedient embodiment of the invention, at least one micro controller is provided for controlling or diagnosing the device. This micro controller comprises an optional memory for storing defined events such as errors or even the fact that threshold values have been exceeded. It is advantageous to provide such a micro controller with a web server so that it can be operated by means of a conventional personal computer or via an Internet terminal either locally or via the Internet. Moreover, an optional display of certain operating states or operating parameters is provided. In this way, for example, it is possible to display transmission errors, the signal-to-noise ratio, the bit error ratio or the fact that certain thresholds have been exceeded. With optional features, the complete control system can be newly configured by software. In this way, it is possible, for example, to load new memory contents, data tables or even program codes in correspondence with the demands.

According to another expedient embodiment, the device is of a self-learning or adaptive design. This means that it adapts itself dynamically, especially during the movement, to the operating states. This can be achieved, for instance, by the detection of certain operating parameters such as the bit error ratio, the signal amplitude, etc., and by the subsequent adjustment of the controller or the analyzer unit or the filters, respectively. It is particularly expedient for this reason to operate on a fuzzy-logic controller in such a case. For example, the redundancy or the data rate can be set as a function of the transmission errors. This means that in the case of a high number of transmission errors provisions are made for a higher redundancy, for instance. Particularly in the case of rotary movements, especially at a constant speed, it is expedient to store the transmission function via the revolution and to set the control means or the analyzer means or filters, respectively, as a function of the time or the position. This is, of course, also possible in the case of linear movements if information is available relative to the position.

An inventive method serves for broadband signal transmission on a device of the claimed general type in accordance with the introductory clause of claim 1. The method is characterized by an adaptation of the data rate or the size of the data packages to be transmitted in dependence on a desired value. The desired or desired value is preferably formed on the basis of parameters characterizing the actual transmission characteristics of the data transmission path or other properties of the data transmission path, such as the position, the time, etc.

### DESCRIPTION OF THE DRAWINGS

In the following, the invention will be described by exemplary embodiments, without any limitation of the inventive idea, with reference to the drawings.

FIG. 1 illustrates an inventive device in a schematic general form.

FIG. 1 is a general schematic view of an inventive device. The data of a data source (1) is transmitted via a controller (7) and a transmitter (2) to a transmitter conductor array (3). The transmitter conductor array is disposed along the path of the movement that is roughly indicated by the directional arrow (9) and passes on the signals fed by the transmitter. A receiving antenna (4) permits the tapping of the signals of the near field of the transmitter conductor structure. The signals tapped by the antenna are passed on via a receiver (5) and via an analyzer unit (8) to the data sink (6).

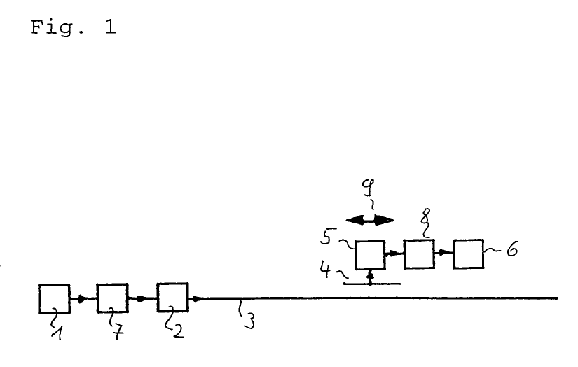

List of Reference Numerals

1 data source

2 transmitter

3 transmitter conductor array

4 receiving antenna

5 receiver

6 data sink

7 controller

8 analyzer unit

9 directional arrow indicating the direction of movement

1. Device for broadband transmission of digital signals between at least one first unit and at least one second unit mobile along a predetermined path relative to said first unit, in particular via non-contacting rotary joints, said first unit comprising:
a data source for generating a serial data stream;
a transmitter for generating electrical signals from said serial data stream from said data source;
a transmitter conductor array for conducting said electrical signals generated by said transmitter;
and said second unit comprising:
a receiving antenna for tapping electrical signals in the near field of said transmitter conductor array;
a receiver for receiving the signals tapped by said receiving antenna;
a data sink for subsequent processing of the signals received by said receiver;
characterized in that a controller is provided for controlling said data stream by signalling a desired value of data rate or data package size to said data source or said transmitter.

2. Device for broadband transmission of digital signals between at least one first unit and at least one second unit mobile along a predetermined path relative to said first unit, said first unit comprising:
a data source for generating a serial data stream;
a transmitter for generating electrical signals from said serial data stream from said data source;
a transmitter conductor array for conducting said electrical signals generated by said transmitter;
and said second unit comprising:
a receiving antenna for tapping electrical signals in the near field of said transmitter conductor array;
a receiver for receiving the signals tapped by said receiving antenna;
a data sink for subsequent processing of the signals received by said receiver;
characterized in that a controller is provided between said data source and said transmitter for controlling said data stream by converting a data rate or data package size of said data source to a desired value of data rate or package size.

3. Device according to claim 1 or 2,
characterized in that said controller comprises means for storing data and for outputting the data at different data rates to said transmitter.

4. Device according to claim 1 or 2,
characterized in that the desired value is predetermined by a desired-value generator according to actual transmission characteristics of a data transmission path between said transmitter and said receiver or according to another measurable value.

5. Device according to claim 1 or 2,
characterized in that an analyzer means is disposed between said receiver and said data sink, that said analyzer means comprises additional means for signaling incorrectly transmitted data to said controller by means of an additionally provided transmission channel, and that said controller means (7) is designed for repeating incorrectly received data packages upon request by said analyzer means.

6 Device according to claim 1 or 2,
charact rized in that a micro controller is provided for controlling and diagnosing the device.

7. Device according to claim 1 or 2,
characterized in that the device is self-learning and adapts itself dynamically to respective conditions of operation.

8. Method of broadband transmission of digital signals between at least one first unit and at least one second unit mobile along a predetermined path relative to said first unit, in particular via non-contacting rotary joints, said first unit comprising:
a data source for generating a serial data stream;
a transmitter for generating electrical signals from said serial data stream from said data source;
a transmitter conductor array for conducting said electrical signals generated by said transmitter;
and said second unit comprising:
a receiving antenna for tapping electrical signals in the near field of said transmitter conductor array;
a receiver for receiving the signals tapped by said receiving antenna;
a data sink for subsequent processing of the signals received by said receiver;
characterized in that a controller is provided for controlling said data stream by signalling a desired value of data rate or data package size to said data source or said transmitter.
